(19) United States
(12) Patent Application Publication
(10) Pub. No.: US 2023/0098969 A1
(43) Pub. Date: Mar. 30, 2023

(54) SIM, COMMUNICATION DEVICE, AND WRITING METHOD FOR APPLICATION

(71) Applicant: NTT Communications Corporation, Tokyo (JP)

(72) Inventors: Masaru HORI, Tokyo (JP); Yamato NOMURA, Tokyo (JP)

(21) Appl. No.: 18/062,259

(22) Filed: Dec. 6, 2022

Related U.S. Application Data
(63) Continuation of application No. PCT/JP2021/007495, filed on Feb. 26, 2021.

(30) Foreign Application Priority Data
Jul. 27, 2020 (JP) 2020-126824

(51) Int. Cl. H04W 8/18; H04W 4/60; H04W 12/069; H04W 12/40

(52) U.S. Cl. CPC H04W 8/183; H04W 4/60; H04W 12/069; H04W 12/40

(57) ABSTRACT

A subscriber identity module (SIM) includes a profile area for storing a profile that is used to utilize a line of a mobile network operator, and an application area for storing an application. The profile area and the application area are separated.

### CROSS-REFERENCE TO RELATED APPLICATIONS

This application is a continuation application of International Application No. PCT/JP2021/007495 filed on Feb. 26, 2021, and designating the U.S., which is based upon and claims priority to Japanese Patent Application No. 2020-126824, filed on Jul. 27, 2020, the entire contents of which are incorporated herein by reference.

### BACKGROUND

### 1. Technical Field

The present disclosure relates to a subscriber identity module (SIM) installed in a communication device.

### 2. Description of the Related Art

A SIM is installed in a communication device such as a mobile terminal, an IoT terminal, or the like for the communication device to use a line of a mobile network operator. There are two types of SIMs: a card-type SIM that is used by being inserted into the communication device, and a chip-type SIM that is integrated into the communication device. In the present specification, these are collectively referred to as the SIM.

The SIM has a profile area that is a secure area having tamper resistance, and the profile area stores a profile that is data required to use a line of a mobile network operator. Additionally, an application (hereafter referred to as an applet) that gives added value to the SIM can be added to the profile area.

In recent years, the profile can be remotely written in the SIM or changed through a network. The mechanism for writing the profile through the network is called remote SIM provisioning (RSP). The SIM configured to use the RSP to write a profile through a network is called an eSIM, and in the present specification, “SIM” includes an eSIM.

### RELATED ART DOCUMENTS

### Patent Documents

[Patent Document 1] Japanese Laid-open Patent Application Publication No. 2014-164565

### SUMMARY

According to one aspect of the present disclosure, a subscriber identity module (SIM) includes a profile area for storing a profile that is used to utilize a line of a mobile network operator, and an application area for storing an application. The profile area and the application area are separated.

### BRIEF DESCRIPTION OF THE DRAWINGS

FIG. 1 illustrates an example of an overall system configuration in an embodiment of the present disclosure;

FIG. 2 is a diagram illustrating an overview of a SIM configuration;

FIG. 3 is a diagram illustrating an example of a configuration in which a profile and an applet are associated;

FIG. 4 is a diagram illustrating a concept of profile switching;

FIG. 5 is a diagram illustrating an example operation of the profile switching;

FIG. 6 is a diagram illustrating an example of a SIM configuration;

FIG. 7 is a diagram illustrating an example of a SIM hardware configuration;

FIG. 8 is a diagram illustrating an example of a SIM software configuration;

FIG. 9 is a diagram illustrating an example operation of applet writing; and

FIG. 10 is a diagram illustrating an example configuration of a communication device in which the SIM is installed.

### DETAILED DESCRIPTION

It is expected that various solutions can be achieved by an applet installed in the SIM. However, in the related art, an applet is stored in the SIM in association with a profile. Thus, if the enabled profile is switched from a first profile to a second profile, an applet associated with the first profile, which is used before the switch, cannot be used.

According to the present disclosure, in a SIM storing profiles and applets, a technique that allows an applet to be used independently of a profile being used is provided.

In the following, an embodiment of the present disclosure will be described with reference to the drawings. The embodiment described below is only an example, and the embodiment, to which the present disclosure is applied, is not limited to the following embodiment.

### Example System Configuration

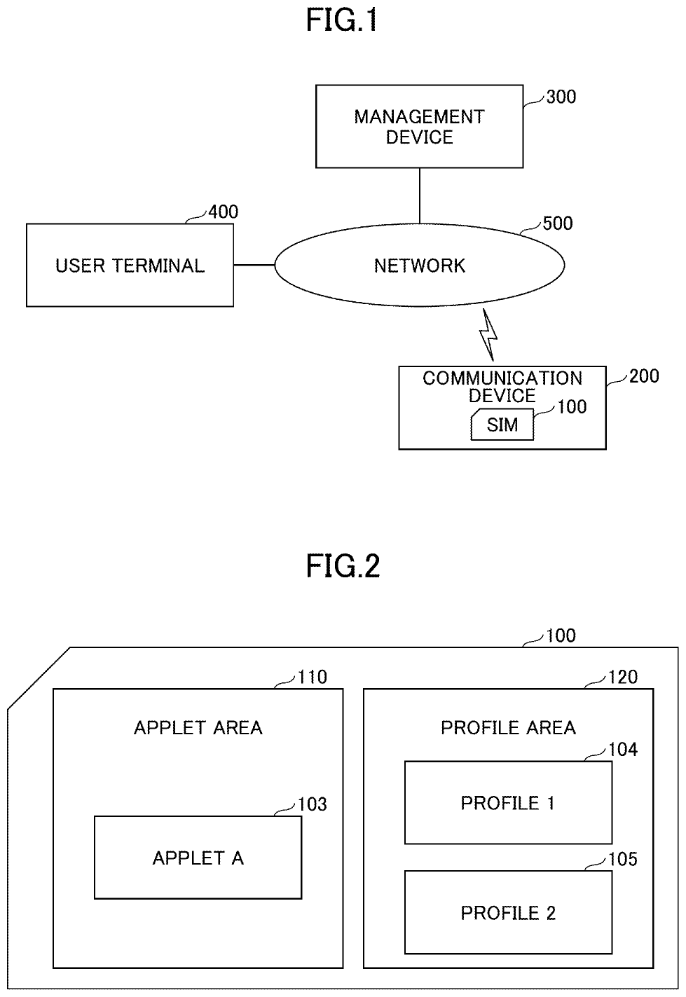

FIG. 1 illustrates an example of a system configuration in the present embodiment. As illustrated in

FIG. 1, the system includes a communication device 200 in which a SIM 100 is installed, a management device 300, a user terminal 400, and a network 500, and respective devices are connected to the network 500.

The SIM 100 is a SIM in which an applet area that is a secure area with tamper resistance and a profile area are separately provided, which will be described in detail later. The SIM 100 may be a card-type SIM or a chip-type SIM.

The communication device 200 is a device having a wireless communication function, and is, for example, a mobile terminal such as a smartphone, a machine to machine (M2M) device, an IoT terminal, or the like. The IoT terminal may be a sensor embedded in a device such as a car, for example. The communication device 200 is not limited to a small device such as a mobile terminal, and may be a PC, a server, a large machine, or the like. Additionally, the communication device 200 may be a SIM reading/writing device.

The management device 300 is a device for creating a profile, managing a profile, transmitting a profile, and the like. The management device 300 has, for example, functions of subscription manager—data preparation (SM-DP), subscription manager—secure routing (SM-SR), and the like.

The user terminal 400 can instruct the management device 300 to switch profiles in the SIM 100. Additionally, the user terminal 400 has a key for accessing an applet area, and can write an applet to the SIM 100.

Here, the user terminal 400 may function as the communication device 200. That is, the communication device 200 itself may instruct the management device 300 to switch profiles and write an applet to the SIM 100 in accordance with a user operation.

The network 500 is a network including a wireless access network, a core network (such as a 5G core), and the Internet. The communication device 200 accesses the Internet from the wireless access network via the core network.

### Outline Configuration of the SIM 100

FIG. 2 is a diagram illustrating an outline configuration of the SIM 100 in the present embodiment. As illustrated in FIG. 2, the SIM 100 includes an applet area 110 for storing applets and a profile area 120 for storing profiles. Additionally, the applet area 110 and the profile area 120 are separated.

Only a mobile network operator having the right to issue the SIM can access the profile area 120, for example. The mobile network operator has a key for accessing the profile area 120, and by using the key, the mobile network operator can access the profile area from the management device 300 and write a profile.

A key for accessing the applet area 110 is different from the key for accessing the profile area 120, and can be provided to a person other than the person having the right to issue the SIM (for example, a third party developing applets).

Hereinafter, the key for accessing the profile area is referred to as a profile area key, and the key for accessing the applet area is referred to as an applet area key.

The applet area key is different for each SIM. That is, an applet area key of one SIM cannot be used to access an applet area of another SIM.

Additionally, multiple applet areas may be provided to the SIM 100. Separate and different applet area keys may be provided for the multiple applet areas in the SIM 100, or an applet area key that can be used in common for the multiple applet areas may be provided.

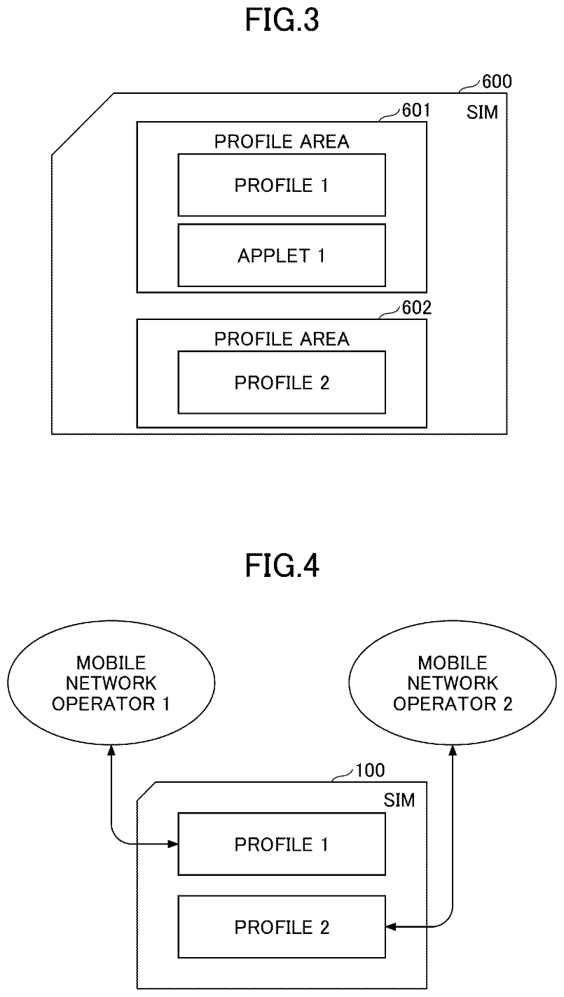

FIG. 3 illustrates an example of a SIM 600 in the related art for comparison. As illustrated in FIG. 3, in the related art, an applet is stored in the profile area, which can be accessed by only a person having the right to issue the SIM, and thus only a person having the right to issue the SIM can write an applet. Thus, it is difficult for the third party developing applets and the like to develop, test, and commercially implement applets.

In the present embodiment, because the third party developing applets and the like can have an applet area key different from a profile area key, the third party developing applets can freely develop an applet, install an applet in SIM 100, test an applet, and commercially implement an applet.

### About Switching Profiles

The profile stored in the SIM 100 includes information for connecting to a network of the mobile network operator (e.g., MSISDN and IMSI) and uses a different profile for each mobile network operator to be connected. When multiple profiles are stored in the SIM 100, one of the profiles becomes an enabled profile and the other profiles become disabled profiles.

The enabled profile is recognized by the communication device 200 and communication is performed using the enabled profile. The disabled profile is not recognized by the communication device 200.

As illustrated in FIG. 4, for example, when a profile 1 of a mobile network operator 1 and a profile 2 of a mobile network operator 2 are stored in the SIM 100, the profile 1 is enabled when the communication device 200 performs communication on the network of the mobile network operator 1, and the profile 2 is enabled when the communication device 200 performs communication on the network of the mobile network operator 2.

Here, in the SIM 600 in the related art illustrated in FIG. 3, a profile 1 and an applet 1 associated with the profile 1 are stored in a profile area 601. Therefore, for example, in a state in which the applet 1 is used in the communication using the profile 1, if the enabled profile is switched from the profile 1 to the profile 2, the profile 1 and the applet 1 associated with the profile 1 cannot be used.

In the SIM 100 of the present embodiment, as illustrated in FIG. 2, the applet area 110 and the profile area 120 are separated so that the applet does not depend on the profile. Thus, for example, even if the communication using the profile 1 is switched to the communication using the profile 2, an applet A can be continuously used.

An example of a sequence during profile switching will be described with reference to FIG. 5. Here, it is assumed that a network used by the communication device 200 for communication is switched from the network of the mobile network operator 1 to the network of the mobile network operator 2.

It is assumed that when the communication device 200 performs communication on the network of the mobile network operator 1 by using the profile 1, the user desires to switch the profile 1 to the profile 2.

In S101, a switching instruction from the profile 1 to the profile 2 is transmitted from the user terminal 400 to the management device 300 based on the user operation. In S102, the switching instruction from the profile 1 to the profile 2 is transmitted from the management device 300 to the SIM 100 via the network of the mobile network operator 1. Here, it is assumed that the profile 2, to which the profile is switched, is already stored in the SIM 100. If the profile 2 is not stored, the profile 2 is downloaded in S102.

In S103, the profile 1 is disabled and the profile 2 is enabled in the SIM 100. When the switching is completed, the communication device 200 performs communication on the network of the mobile network operator 2. In S104, a notification of the switching completion is transmitted from the SIM 100 to the management device 300 via the network of the mobile network operator 2.

In the present embodiment, the applet of the SIM 100 can be continuously used even when the profile is switched as described above.

### Detailed Configuration Example of the SIM 100

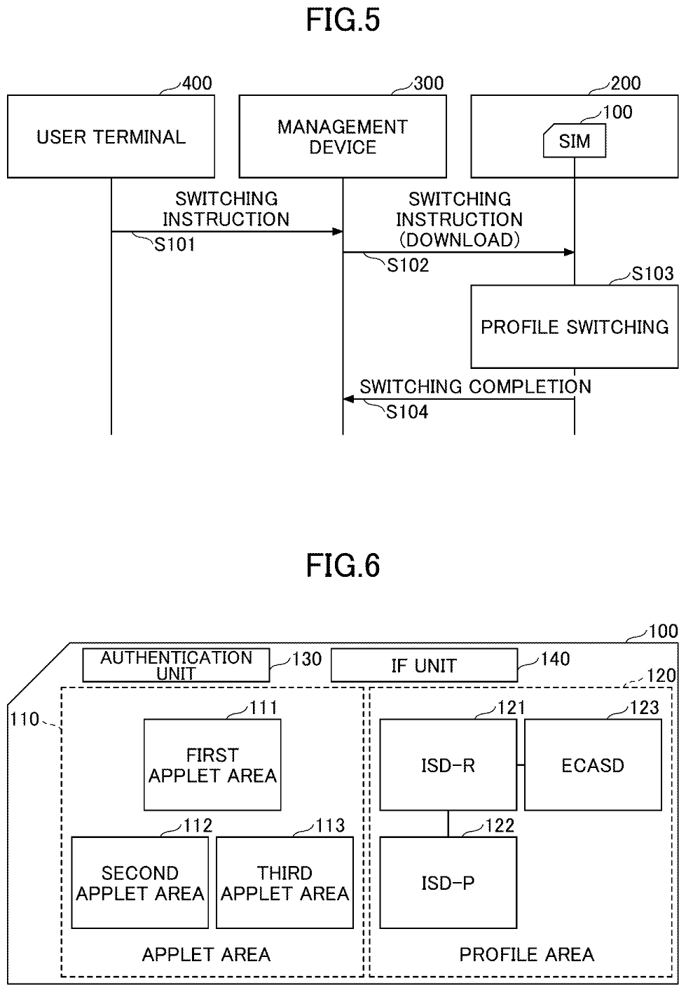

FIG. 6 is a diagram illustrating a detailed configuration example of the profile area 120 and the applet area 110 of the SIM 100. The profile area 120 itself has substantially the same configuration as the profile area in the related art and has ISD-R121, ISD-P122, and ECASD 123. ISD-R stands for issuer security domain root. ISD-P stands for issuer security domain profile. ECASD stands for eUICC controlling authority security domain.

ISD-R121 is an interface between the inside of SIM 100 and the outside of the SIM 100. ISD-P122 is created for each installed profile. ECASD 123 is an area that stores a key used to protect data when downloading a profile.

In the example illustrated in FIG. 6, three applet areas, a first applet area 111, a second applet area 112, and a third applet area 113, are in the applet area. The number of the applet areas is not particularly limited, and there may be two or less applet areas, or four or more applet areas. Here, the applet area may be referred to as a secure element or a secure domain. Additionally, an applet may be referred to as an application.

Additionally, an authentication unit 130 that performs authentication when accessing the applet area, and an IF unit 140 that is an interface between the inside and outside of the SIM 100 with respect to the applet are illustrated in FIG. 6. Here, it is assumed that the authentication unit 130 and the IF unit 140 are functional units for the applet area, but the authentication unit 130 and the IF unit 140 may be common to the applet area and the profile area.

When the authentication unit 130 receives, for example, an access (an authentication request) using an applet area key from the user terminal 400, the authentication unit 130 reads corresponding key information from the applet area and performs authentication processing by using the key information. Additionally, the IF unit 140 writes, for example, an applet received from the user terminal 400 into the applet area.

Each applet area may store one or more applets. Additionally, an applet area key is individually provided to the user for each applet area. For example, a first applet area key for accessing a first applet area 111, a second applet area key for accessing a second applet area 112, and a third applet area key for accessing a third applet area 113 are provided.

For example, a first user who has received the first applet area key can access the first applet area 111, a second user who has received the second applet area key can access the second applet area 112, and a third user who has received the third applet area key can access the third applet area 113. Here, the first user, the second user, and the third user may be three different users or one identical user.

Each applet area stores a key corresponding to the applet area key. For example, a key corresponding to the first applet area key is stored in the first applet area 111, a key corresponding to the second applet area key is stored in the second applet area 112, and a key corresponding to the third applet area key is stored in the third applet area 113.

The authentication scheme is not limited to a specific scheme, but for example, when the ID/password scheme is used as the authentication scheme, the applet area key is an ID and a password, and the same ID and password as the applet area key are stored as the key corresponding to the applet area key. Additionally, for example, when a scheme that uses a private key and a public key is used as the authentication scheme, the applet area key is the private key, and the key corresponding to the applet area key is the public key.

The SIM 100 can authenticate the access using the applet area key by reading the key corresponding to the applet area key from the applet area and using the key corresponding to the applet area key. Here, the key corresponding to the applet area key may be stored in an area different from the applet area.

As illustrated in FIG. 6, when the SIM 100 includes multiple applet areas, the applet area keys may be provided to different destinations depending on how the applet areas are used.

For example, the first applet area 111 may be defined as an area that can be accessed only by a partner company of a company having the right to issue the SIM 100, and the first applet area key may be provided only to the partner. This allows, for example, the partner to write an applet developed by the partner or provided by an applet development vendor to the first applet area 111 of the SIM 100.

Additionally, for example, the second applet area 112 may be defined as an area that can be accessed only by a company having the right to issue the SIM, and the second applet area key may be provided only to the company having the right to issue the SIM. In this case, for example, an applet developed by an applet development vendor can be written into the second applet area 112 of the SIM 100 by the company having the right to issue the SIM.

Additionally, for example, the third applet area 113 may be defined as an area that can be accessed only by an applet development vendor, and the third applet area key is provided to the applet development vendor. In this case, the applet development vendor can write an applet developed by the applet development vendor to the third applet area 113.

### Example Hardware/Software Configuration of the SIM 100

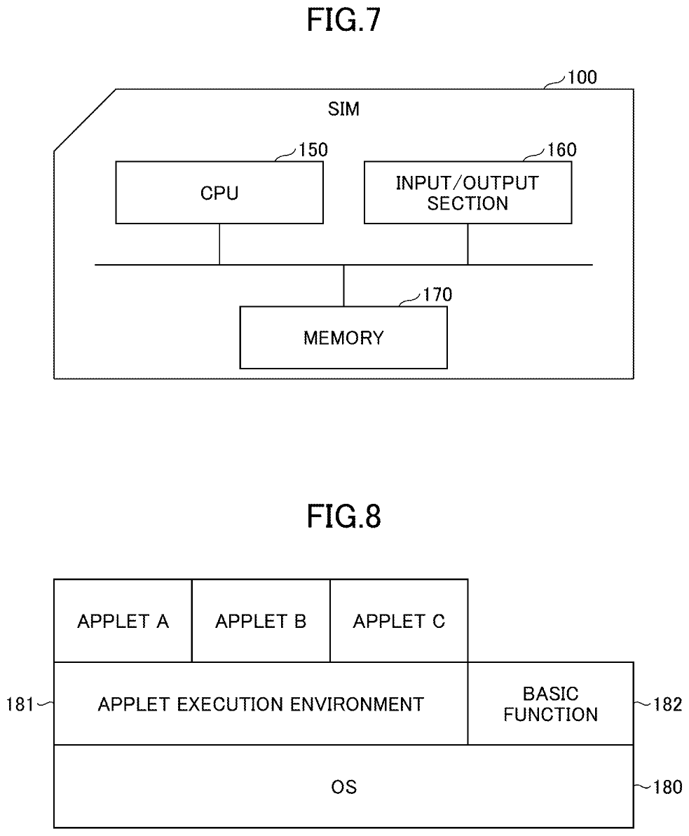

FIG. 7 illustrates an example of a hardware configuration of the SIM 100. As illustrated in FIG. 7, the SIM 100 includes a central processing unit (CPU) 150, a memory 170, and an input/output section 160.

The CPU 150 is a processor that reads programs stored in the memory 170 and performs processing according to instructions of the programs. Such programs include an operating system (OS), an applet execution environment, an applet, a program for authentication processing, a program for communication processing, a profile enabler, and the like. The input/output section 160 is an interface with the communication device 200. The functions of the IF unit 140 described above are included in the input/output section 160.

Data such as profiles, applets, and programs other than applets are stored in the memory 170.

The applet area for storing the applet and the profile area for storing the profile in the present embodiment are implemented by, for example, the memory 170 (a storage section). The separation of the applet area and the profile area may be achieved by physically separating areas in the memory 170 or by using multiple memories (a memory for the applet area and a memory for the profile area). Alternatively, the separation of the applet area and the profile area may be achieved by another method.

FIG. 8 is a diagram illustrating an example of a software configuration of the SIM 100. As illustrated in FIG. 8, an OS 180 runs as software of the SIM 100, and software implementing an applet execution environment 181 and a basic function 182 such as authentication runs on the OS 180. Additionally, each applet runs on the applet execution environment 181.

### Example of Operation Related to Writing Applet

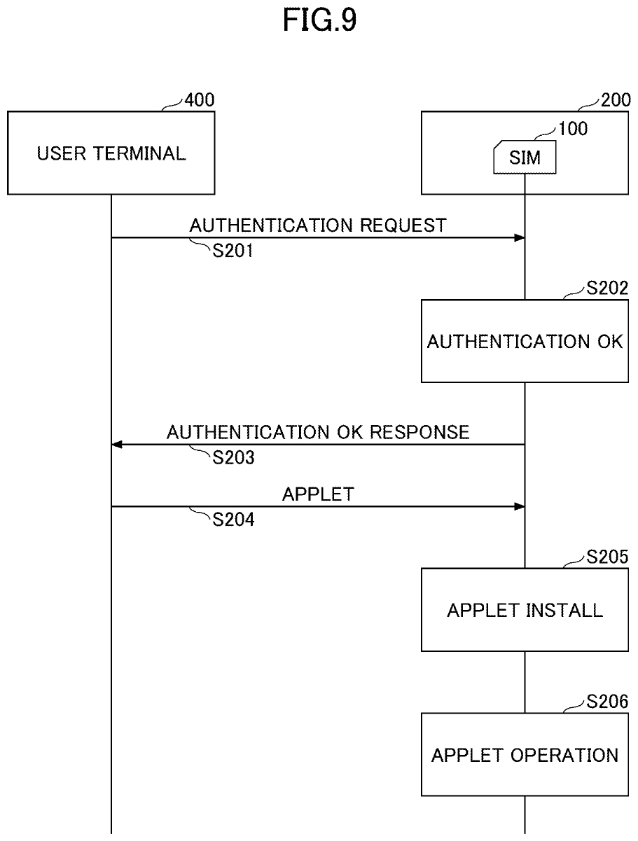

An operation example of writing an applet from the user terminal 400 to the SIM 100 will be described with reference to FIG. 9. Here, an example of writing an applet in the third applet area 113 illustrated in FIG. 6 will be described.

The user terminal 400 securely stores the third applet area key. First, in S201, the user terminal 400 transmits an authentication request to the SIM 100. In S202, the SIM 100 performs authentication processing for the user terminal 400 based on the authentication request. Here, it is assumed that the authentication is successful. In S203, SIM 100 returns an authentication OK response to the user terminal 400.

With respect to the above-described authentication processing, as an example, when the ID/password authentication is performed, the authentication request includes the ID and password as the third applet area key. The SIM 100 compares the key information (the ID and password) stored in the third applet area with the third applet area key, and if they match, the SIM 100 determines that the authentication is OK.

Additionally, as an example, when the authentication is performed using a private key and a public key, the authentication processing can be performed by various methods, but for example, the authentication processing can be performed by the following method.

Upon receiving the authentication request from the user terminal 400, the SIM 100 returns a random number to the user terminal 400. The user terminal 400 generates an electronic signature by encrypting the random number by using the private key, which is the third applet area key, and transmits the electronic signature to the SIM 100. The SIM 100 decrypts the electronic signature by using the public key stored in the third applet area and determines that the authentication is OK if the decrypted electronic signature matches the original random number.

The authentication method described above is merely an example and any authentication method may be used. For example, a method using an electronic certificate or a method using a common key may be used.

Additionally, in the example illustrated in FIG. 9, the applet is transmitted after the SIM 100 authenticates the user terminal 400, but in addition to the SIM 100 authenticating the user terminal 400, the user terminal 400 may authenticate the SIM 100 before the applet is transmitted.

In S204 of FIG. 9, the user terminal 400 transmits the applet to the SIM 100. The SIM 100 receives the applet and stores (installs) the received applet in the third applet area in S205. In S206, the applet is activated and starts operating according to the applet specification.

The applet in the present embodiment is not limited to a specific applet, but, for example, is an applet that accumulates quality information of the line used by the communication device 200 for communication and periodically uploads the quality information to the server. By using such an applet, the communication device 200 can continuously transmit the quality information even when the profile is switched across the national border, so that the line quality can be grasped on a global level.

Additionally, there is an applet achieving a function of a credit card or a public card, and an applet for unlocking and locking a house, a car, and the like.

### Example Configuration of the Communication Device 200 in which the SIM 100 is Installed

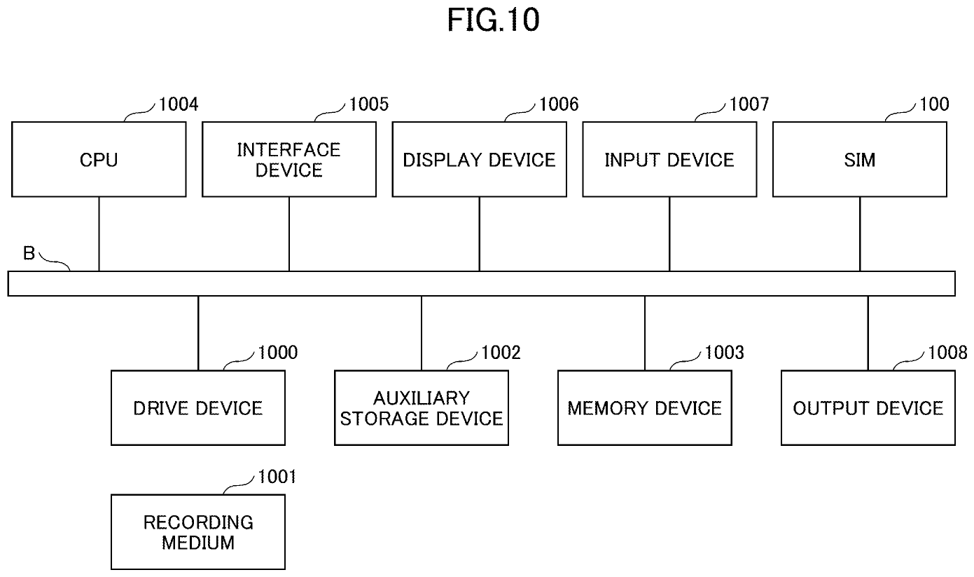

FIG. 10 illustrates an example configuration of the communication device 200 in which the SIM 100 is installed. A mobile terminal, an IoT terminal, a server, various machines, or the like, which are assumed to be communication devices 200, includes a computer having a CPU, a memory, and the like, as illustrated in FIG. 10, as a basic configuration.

The communication device 200 illustrated in FIG. 10 includes a drive device 1000, an auxiliary storage device 1002, a memory device 1003, a CPU 1004, an interface device 1005, 1005, a display device 1006, an input device 1007, an output device 1008, and the like, which are connected to each other by a bus B. Additionally, as illustrated in the drawing, the SIM 100 is connected.

A program implementing the processing in the communication device 200 is provided by a recording medium 1001 such as a memory card, for example. When the recording medium 1001 storing the program is set in the drive device 1000, the program is installed from the recording medium 1001 to the auxiliary storage device 1002 via the drive device 1000. However, it is not necessary to install the program from the recording medium 1001, and the program may be downloaded from another computer through the network. The auxiliary storage device 1002 stores the installed program and stores necessary files, data, and the like.

When an instruction to start a program is received, the memory device 1003 reads the program from the auxiliary storage device 1002 and stores the program. The CPU 1004 achieves the function of the communication device 200 according to the program stored in the memory device 1003. The interface device 1005 is a communication device used as an interface for connecting to the network. The display device 1006 displays a graphical user interface (GUI) or the like implemented by the program. The input device 1007 includes a keyboard and a mouse, buttons, a touch panel, or the like, and is used to input various operating instructions. The output device 1008 outputs an arithmetic result.

In the configuration of FIG. 10, for example, the authentication request from the user terminal 400 is input to the communication device 200 by the interface device 1005 and transmitted to the SIM 100. A result of the processing performed by the SIM 100 (authentication OK or the like) is passed to the interface device 1005 and transmitted from the interface device 1005 to the user terminal 400. Additionally, the applet transmitted from the user terminal 400 is input to the communication device 200 by the interface device 1005, transmitted to the SIM 100, and stored in the applet area in the SIM 100.

### Effect of the Embodiment

As described above, in the present embodiment, because the profile area and the applet area in the SIM 100 are separated, the operating state of the applet is not affected by the enabled state or the disabled state of the profile. This allows the applet to remain in operation at all times, even when profile switching occurs.

Additionally, the SIM of the present embodiment allows a user having an individual key to the applet area to access the applet area. This can prepare an environment for performing a test, in which the created applet runs on the SIM 100, without affecting the profile.

### Summary of the Embodiment

The present specification describes, at least, a SIM, a communication device, and an application writing method described in the following:

### Item 1

A SIM including a profile area for storing a profile that is used to utilize a line of a mobile network operator, and an application area for storing an application,

wherein the profile area and the application area are separated.

### Item 2

The SIM described in Item 1, wherein a key used to access the application area differs from a key used to access the profile area.

### Item 3

The SIM described in Item 1 or 2,

wherein a first profile and a second profile are stored in the profile area, and

wherein the application continues to run on the SIM after a profile that can be used is switched from the first profile to the second profile.

### Item 4

The SIM described in any one of Item 1 to 3, including a plurality of application areas, wherein respective keys used to access the plurality of application areas are different from each other.

### Item 5

A communication device in which the SIM as described in any one of Item 1 to 4 is installed.

Item 6

An application writing method in a system including a user terminal and a communication device in which the SIM as described in any one of Item 1 to 4, the application writing method including:

accessing, by the user terminal, the SIM by using a key for accessing the application area;

transmitting, by the user terminal, the application to the SIM, upon determining that authentication performed by the SIM is successful; and

writing, by the SIM, the application into the application area.

Although the present invention has been described above, the present invention is not limited to such a specific embodiment, and various modifications and alterations can be made within the scope of the subject matter of the invention recited in the claims.

What is claimed is:

1. A subscriber identity module (SIM) comprising:
a profile area for storing a profile that is used to utilize a line of a mobile network operator; and
an application area for storing an application,
wherein the profile area and the application area are separated.

2. The SIM as claimed in claim 1, wherein a key used to access the application area differs from a key used to access the profile area.

3. The SIM as claimed in claim 1,
wherein a first profile and a second profile are stored in the profile area, and
wherein the application continues to run on the SIM after a profile that can be used is switched from the first profile to the second profile.

4. The SIM as claimed in claim 1, comprising a plurality of application areas,
wherein respective keys used to access the plurality of application areas are different from each other.

5. A communication device in which the SIM as claimed in claim 1 is installed.

6. An application writing method in a system including a user terminal and a communication device in which the SIM as claimed in claim 1 is installed, the application writing method comprising:
accessing, by the user terminal, the SIM by using a key for accessing the application area;
transmitting, by the user terminal, the application to the SIM, upon determining that authentication performed in the SIM is successful; and
writing, by the SIM, the application into the application area.

7. The SIM as claimed in claim 2,
wherein a first profile and a second profile are stored in the profile area, and
wherein the application continues to run on the SIM after a profile that can be used is switched from the first profile to the second profile.

8. The SIM as claimed in claim 7, comprising a plurality of application areas,
wherein respective keys used to access the plurality of application areas are different from each other.

9. A communication device in which the SIM as claimed in claim 2 is installed.

10. A communication device in which the SIM as claimed in claim 3 is installed.

11. A communication device in which the SIM as claimed in claim 4 is installed.

12. A communication device in which the SIM as claimed in claim 7 is installed.

13. A communication device in which the SIM as claimed in claim 8 is installed.

14. An application writing method in a system including a user terminal and a communication device in which the SIM as claimed in claim 2 is installed, the application writing method comprising:
accessing, by the user terminal, the SIM by using a key for accessing the application area;
transmitting, by the user terminal, the application to the SIM, upon determining that authentication performed in the SIM is successful; and
writing, by the SIM, the application into the application area.

15. An application writing method in a system including a user terminal and a communication device in which the SIM as claimed in claim 3 is installed, the application writing method comprising:
accessing, by the user terminal, the SIM by using a key for accessing the application area;
transmitting, by the user terminal, the application to the SIM, upon determining that authentication performed in the SIM is successful; and
writing, by the SIM, the application into the application area.

16. An application writing method in a system including a user terminal and a communication device in which the SIM as claimed in claim 4 is installed, the application writing method comprising:
accessing, by the user terminal, the SIM by using a key for accessing the application area;
transmitting, by the user terminal, the application to the SIM, upon determining that authentication performed in the SIM is successful; and
writing, by the SIM, the application into the application area.

17. An application writing method in a system including a user terminal and a communication device in which the SIM as claimed in claim 7 is installed, the application writing method comprising:
accessing, by the user terminal, the SIM by using a key for accessing the application area;
transmitting, by the user terminal, the application to the SIM, SIM, upon determining that authentication performed in the SIM is successful; and
writing, by the SIM, the application into the application area.

18. An application writing method in a system including a user terminal and a communication device in which the SIM as claimed in claim 8 is installed, the application writing method comprising:
accessing, by the user terminal, the SIM by using a key for accessing the application area;
transmitting, by the user terminal, the application to the SIM, upon determining that authentication performed in the SIM is successful; and
writing, by the SIM, the application into the application area.
